(19) United States
(12) Patent Application Publication
(10) Pub. No.: US 2026/0109621 A1
(43) Pub. Date: Apr. 23, 2026

(54) UPCYCLING METHOD OF DEGRADED CATHODE MATERIALS FOR LITHIUM ION BATTERIES

(71) Applicant: CASE WESTERN RESERVE UNIVERSITY, Cleveland, OH (US)

(72) Inventors: Yu Wang, Cleveland, OH (US); Chris Yingchun Yuan, Solon, OH (US)

(21) Appl. No.: 19/364,282

(22) Filed: Oct. 21, 2025

Related U.S. Application Data
(60) Provisional application No. 63/709,710, filed on Oct. 21, 2024.

(51) Int. Cl. C01G 53/504; H01M 10/0525; H01M 10/54

(52) U.S. Cl. CPC C01G 53/504; H01M 10/0525; H01M 10/54; C01P 2004/84; C01P 2006/37; C01P 2006/40

(57) ABSTRACT

A method for upcycling degraded cathode materials for lithium-ion batteries includes applying a precursor coating layer to degraded cathode particles and sintering the precursor coated degraded cathode particles to simultaneously directly regenerate and convert the coating layer precursor to a lithium oxide or lithium metal oxide coating layer and obtain the upcycled cathode material with improved electrochemical performance.

### RELATED APPLICATION

This application claims priority from U.S. Provisional Application No. 63/709,710, filed Oct. 21, 2024, the subject matter of which is incorporated herein by reference in its entirety.

### GOVERNMENT FUNDING

This invention was made with government support under 2101129 awarded by the National Science Foundation. The government has certain rights in the invention.

### BACKGROUND

Lithium-ion batteries are extensively used in electric vehicles due to their high energy density and safety features. With the surge in demand for these batteries, a significant number are now reaching the end of their life cycle, typically after 5-10 years of use. These spent batteries contain valuable components, making their recycling economically beneficial. However, the disposal of lithium-ion batteries poses serious environmental risks, including the emission of harmful gases and the release of toxic electrolytes, which can contaminate air, water, and soil. Notably, the cathode materials in these batteries, which contain valuable transition metals, account for over 35% of the total battery cost, highlighting the importance of recycling to reduce costs and enhance industry sustainability. Currently, the primary methods for recycling lithium-ion batteries include pyrometallurgy, hydrometallurgy, and direct recycling. Direct recycling is particularly notable for regenerating spent cathode materials without the need for complex resynthesis processes, making it more energy-efficient and less chemically intensive, while generating minimal waste. This method has become a research focal point, with efforts concentrated on restoring lithium and addressing structural degradation in used cathode materials, thereby enhancing their reusability and efficiency in new battery production.

However, directly recycled cathode materials often do not meet the high electrochemical performance and stability required for lithium-ion batteries in electric vehicles, which need to achieve long driving ranges and superior safety. To address these challenges, researchers have proposed upcycling methods to enhance the electrochemical performance by improving the composition of degraded cathode materials. For instance, a selective lithium extraction method has been used to homogenize the particle size of spent NCM622, subsequently upcycling it to single-crystalline NCM811 through high-temperature sintering with Ni(OH)₂ and LiOH. Similarly, a flux upcycling approach was developed transforming spent NCM111 into NCM622 using a reciprocal ternary molten salt system. However, current upcycling methods are limited to cathode materials with flexible compositions, such as NCM and NCA, and often consume significant amounts of valuable transition metal salts. Additionally, the aggressive composition can reduce the stability of upcycled cathode materials during cycling.

### SUMMARY

Embodiments described herein relate to a method for upcycling degraded cathode materials of lithium-ion batteries. The method includes applying a precursor coating layer to degraded lithium ion cathode material particles with lithium loss by wet chemical methods. The precursor layer coated lithium cathode material particles are then sintered with a lithium ion source at a temperature and for a duration of time effective to restore the lithium component of the lithium ion cathode material particles and convert the precursor coating layer to a lithium oxide or lithium metal oxide coating layer effective to enhance the electrochemical and/or thermal properties of the lithium ion battery cathode material particles.

In some embodiments, the precursor coating layer is applied to the degraded lithium ion cathode material particles with lithium loss by dispersing the degraded lithium ion cathode material particles in a precursor coating solution containing a metal salt and adding a basic solution to the dispersion to facilitate deposition of the precursor coating layer that includes a metal of the metal salt on the dispersed degraded lithium ion cathode material particles.

In some embodiments, the degraded cathode material is selected from LiNiCoMnO₂ (NCM) LiCoO₂ (LCO), LiMn₂O₄ (LMO), LiFePO₄ (LFP), LiNiMnCoO₂ (NMC), LiNiCoAlO₂ (NCA), LiNiO₂, LiCrO₂, LiV₂O₅, LiTiS₂, LiMOS₂, LiMnO₂, lithium nickel oxides, lithium nickel manganese oxides, lithium nickel manganese cobalt oxides, LiNi_{0.333}Co_{0.333}Mn_{0.333}O₂ (NCM111), LiNi_{0.5}Co_{0.2}Mn_{0.3}O₂ (NCM523), LiNi_{0.6}Co_{0.2}Mn_{0.2}O₂ (NCM622), LiNi_{0.7}Co_{0.1}Mn_{0.2}O₂, or LiNi_{0.8}Co_{0.1}Mn_{0.1}O₂ (NCM811), each with at least about 10% or more Li loss.

In some embodiments, the metal salt in the precursor coating solution can be selected from aluminum nitrate, titanium chloride, magnesium nitrate, zinc nitrate, lithium silicate, lithium titanate, lithium zirconate, or mixtures thereof.

In some embodiments, the basic solution can be selected from ammonium hydroxide (NH₄OH), sodium hydroxide (NaOH), potassium hydroxide (KOH), sodium carbonate (Na₂CO₃), sodium bicarbonate (NaHCO₃), lithium hydroxide (LiOH), or mixtures thereof.

In some embodiments, the lithium oxide or lithium metal oxide coating layer can include about 1 wt. % to about 5 wt. % of the upcycled lithium ion cathode material.

In some embodiments, the precursor layer coated lithium cathode material particles and lithium ion source are sintered at a temperature of about 500° C. to about 700° C., preferably, about 600° C.

In some embodiments, the degraded lithium ion cathode material particles or upcycled lithium ion cathode material particles can be doped with at least one of Mg, Al, Ti, V, Zn, Nb, W, Ca, etc.

In some embodiments, the method further includes filtering, washing, and drying the precursor layer coated lithium ion cathode material particles before mixing the precursor layer coated lithium ion cathode material particles with the lithium ion source.

In some embodiments, the lithium source includes particulate lithium hydroxide.

In some embodiments, the method further includes washing and drying the upcycled lithium ion cathode material particles.

In some embodiments, the precursor coating layer of the precursor layer coated lithium ion cathode material particles prior to sintering includes a metal, metal oxide, or metal hydroxide coating.

In some embodiments, the metal oxide or metal hydroxide coating can include at least one of Al(OH)₃, Al₂O₃, TiO₂, MgO, ZnO, Li₂SiO₃, Li₂TiO₃, LiZrO₃ or mixtures thereof.

In some embodiments, the metal hydroxide coating can include an Al(OH)₃ coating.

In some embodiments, the Al(OH)₃ coating can be formed on the degraded lithium ion cathode material particles by mixing the particles with an aqueous solution of Al(NO₃)₃ and adding an NH₃·H₂O solution to the mixture at an amount effective to coat the degraded lithium ion cathode material particles with Al(OH)₃.

In some embodiments, the mixture of degraded lithium ion cathode material particles and Al(NO₃)₃ can be stirred at a temperature of about 40° C. to about 60° C., e.g., about 50° C., for 5 minutes to about 20 minutes, e.g., about 10 minutes.

In some embodiments, the mixture can be heated to a temperature of about 70° C. to about 90° C. prior to adding the NH₃·H₂O solution to the mixture.

In some embodiments, the lithium oxide or lithium metal oxide coating can include a LiAlO₂ coating.

In some embodiments, the upcycled lithium ion cathode material exhibits a higher discharge capacity and capacity retention compared to pristine cathode material of the same composition.

In some embodiments, the upcycled lithium ion cathode material exhibits improved rate capability compared to pristine cathode material of the same composition.

In some embodiments, the upcycled lithium ion cathode material exhibits enhanced thermal stability, with, for example, less than 1% weight loss at temperatures up to 400° C., compared to a pristine cathode material.

Other embodiments described herein relate to an upcycled cathode material for lithium-ion batteries produced by the method described herein.

Still other embodiments described herein relate to a lithium-ion battery that includes the upcycled cathode material.

In some embodiments, the battery can exhibit improved electrochemical performance and thermal stability compared to a battery using pristine cathode material of the same or similar composition.

### BRIEF DESCRIPTION OF THE DRAWINGS

FIG. 1 is a flowchart of the upcycling process in accordance with an embodiment described herein.

FIG. 2 is a schematic diagram of two-step upcycling process.

FIG. 3 illustrates a plot showing the cycling performance of Up-NCM622@4.6V, P-NCM811@4.3V, and P-NCM622@4.3V.

FIG. 4 illustrates plots showing the rate capability of P-NCM, Up-NCM, and D-NCM at 4.6V.

FIG. 5 illustrates plots showing the thermal stability of P-NCM, Up-NCM, and D-NCM.

### DETAILED DESCRIPTION

For convenience, certain terms employed in the specification, examples, and appended claims are collected here. Unless defined otherwise, all technical and scientific terms used herein have the same meaning as commonly understood by one of ordinary skill in the art to which this application belongs.

The articles “a” and “an” are used herein to refer to one or to more than one (i.e., to at least one) of the grammatical object of the article. By way of example, “an element” means one element or more than one element.

The terms “comprise,” “comprising,” “include,” “including,” “have,” and “having” are used in the inclusive, open sense, meaning that additional elements may be included. The terms “such as”, “e.g.,”, as used herein are non-limiting and are for illustrative purposes only. “Including” and “including but not limited to” are used interchangeably.

The term “or” as used herein should be understood to mean “and/or”, unless the context clearly indicates otherwise.

The term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

As used herein, “one or more of a, b, and c” means a, b, c, ab, ac, bc, or abc. The use of “or” herein is the inclusive or.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

Embodiments described herein relate to a method for upcycling degraded cathode materials of lithium ion batteries. The method can utilize outdated, spent, or degraded cathode materials with significant capacity loss and transform the outdated, spent, or degraded cathode materials into high-performance cathode materials. The method combines direct recycling processes with advanced coating techniques to restore the composition and crystal structure of the degraded cathode materials, thereby enhancing the electrochemical performance and thermal stability of cathode materials for lithium-ion batteries.

The method includes a two-step upcycling where, in a first step, a precursor coating layer, such as Al₂O₃, is applied to outdated, spent, or degraded lithium ion battery cathode particles by wet chemical methods and, in a second step, the precursor coating layer covered lithium ion battery cathode particles are directly regenerated by sintering processes with a lithium ion source such that the lithium component of the cathode particles is restored to the amount of lithium in the cathode particles of pristine commercially available lithium ion batteries and the precursor coating layer is converted to a metal oxide coating layer, such as LiAlO₂, effective to enhance the electrochemical and/or thermal properties of the upcycled lithium ion battery cathode particles; thus providing a unique combination of replenishing, coating, and coating material conversion in a single thermal treatment.

This innovative combined approach can significantly enhance the electrochemical performance and thermal stability of the degraded lithium ion cathode material. Unlike traditional methods, the upcycling process described herein does not necessitate high temperatures, long sintering duration and uses only low-cost salts instead of expensive transition metal salts. The upcycled cathode materials produced by this method match the composition of pristine materials with an advanced ultrathin metal oxide (e.g., LiAlO₂) coating layer, comparable electrochemical performance, and thermal stability to advanced cathode materials in current electric vehicles, and with improvements observed in cut-off voltage, specific capacity, cycling stability, rate capability, and thermal stability.

This upcycling method represents a significant advancement in lithium-ion battery recycling technology, offering a cost-effective, efficient, and high-performance solution to address the growing need for sustainable battery materials by demonstrating that end-of-life cathode materials can be transformed into high-performance components while reducing the environmental footprint of battery production. By transforming outdated cathode materials from retired EV batteries into materials with performance comparable to those used in current EVs, this method provides a crucial link in the sustainable lifecycle of electric vehicle batteries. The successful implementation of such upcycling approaches can dramatically reduce the need for primary raw material extraction while providing high-quality materials for next-generation batteries. This upcycling method establishes a new pathway toward circular material flows in the battery industry, contributing to both resource conservation and sustainable manufacturing practices

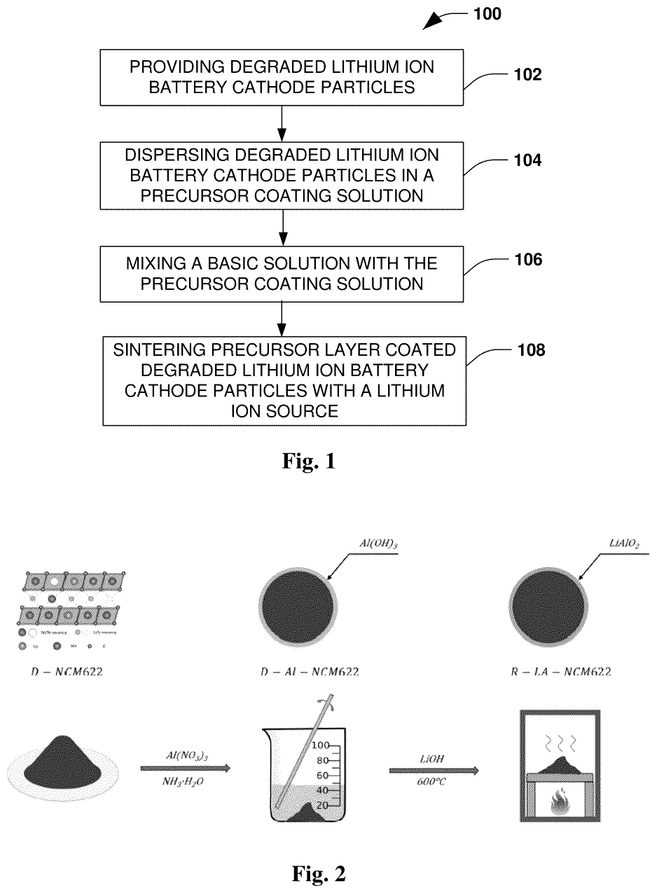

FIG. 1 illustrates a flow diagram of a method 100 for upcycling degraded cathode materials for lithium-ion batteries in accordance with an embodiment described herein. The method 100 begins at step 102 with providing a plurality of degraded lithium ion battery cathode particles. The degraded lithium ion battery cathode particles can be obtained from used, spent, or degraded lithium ion battery cathodes of lithium ion batteries that have reached the end of their useful lifespan. The degraded lithium ion battery cathode particles may also be obtained from new lithium-ion batteries that have a charging capacity of 90% or less, preferably 50% or less, and more preferably 30% or less. Additionally, degraded lithium ion battery cathode particles may also be obtained from cathode scraps (CS), which are waste materials generated during a battery manufacturing process, as well as lithium-ion battery cells discarded due to production defects that prevent their sale or distribution in the market.

The degraded lithium ion battery cathodes can include potentially any degraded lithium ion battery cathode material. Examples of degraded lithium ion battery cathode materials can include degraded LiNiCoMnO₂ (NCM) LiCoO₂ (LCO), LiMn₂O₄ (LMO), LiFePO₄ (LFP), LiNiMnCoO₂ (NMC), LiNiCoAlO₂ (NCA), LiNiO₂, LiCrO₂, LiV₂O₅, LiTiS₂, LiMOS₂, LiMnO₂, as well as variations of lithium nickel oxides, lithium nickel manganese oxides, lithium nickel manganese cobalt oxides, and the like exemplified by those having general formulas LiNiₓMn_{y}O₂, Li_{1-z}, NiₓMn_{y}Co_{1-x-y}O₂, LiNiₓCo_{y}Al₂O₂, LiNiₓCo_{y}Mn₂O₂, where each x, y, and z is typically a mole fraction of from 0 to 1, each with, for example, at least about 10%, at least about 15%, at least about 20%, at least about 25%, at least about 30%, at least about 35%, at least about 40%, or more Li loss. In some embodiments, the degraded lithium ion cathode battery material can be LiNi_{0.333}Co_{0.333}Mn_{0.333}O₂ (NCM111), LiNi_{0.5}Co_{0.2}Mn_{0.3}O₂ (NCM523), LiNi_{0.6}Co_{0.2}Mn_{0.2}O₂ (NCM622), LiNi_{0.7}Co_{0.1}Mn_{0.2}O₂, or LiNi_{0.8}Co_{0.1}Mn_{0.1}O₂ (NCM811) each with, for example, at least about 10%, at least about 15%, at least about 20%, at least about 25%, at least about 30%, at least about 35%, at least about 40%, or more Li loss.

In some embodiments, mechanical separation processes can be applied to degraded or spent lithium ion batteries to separate the degraded lithium ion battery cathode material from the outer cases and shells as well as the plastic fractions. The degraded lithium ion battery cathode can be crushed or milled and then sieved to provide a mixed lithium ion battery cathode material that includes the lithium ion battery cathode material, binder, and other impurities. The binder and other impurities can be removed from the mixed particulate material by leaching or solvent removal processes to provide purified particulates of the degraded lithium ion battery cathode material.

In some embodiments, the degraded lithium ion battery cathode particles can have an average particle size of about 1 μm to about 10 mm, for example, about 2 μm to about 5 mm, about 5 μm to about 1 mm, or about 10 μm to about 100 μm, including ranges between any of the foregoing values.

At step 104, the plurality of degraded lithium ion battery cathode particles can be dispersed in a precursor coating solution that includes a metal salt. The metal salt can be capable of serving as a metal source for a precursor coating layer that is formed or precipitated on the plurality of degraded lithium ion battery cathode particles by subsequent reaction with a basic solution. Advantageously, the precursor coating layer, including the metal source, can promote lithium migration to the plurality of degraded lithium ion battery cathode particles and be capable of reacting with a lithium ion source to form a lithium ion coating layer on the plurality of degraded lithium ion battery cathode particles. The precursor coating solution can be prepared by dissolving a metal salt in an aqueous solution, such as distilled water, and stirring the metal salt at an elevated temperature until dissolved.

In some embodiments, the metal salt can include aluminum nitrate, titanium chloride, magnesium nitrate, zinc nitrate, lithium silicate, lithium titanate, lithium zirconate, or mixtures thereof, preferably, aluminum nitrate (Al(NO₃)₃), and the metal salt can be stirred in the aqueous solution at an elevated temperature of about 30° C. to about 60° C., about 35° C. to about 60° C., about 40° C. to about 60° C., about 45° C. to about 60° C., about 45° C. to about 55° C., or about 50° C., including ranges between any of the foregoing values.

In some embodiments, the precursor salt solution can have a melt salt concentration of about 0.01M to about 10M, about 0.01M to about 5M, about 0.01M to about 2M, about 0.01M to about 1M, about 0.01M to about 0.5M, or 0.01M to about 0.1M, including ranges between any of the foregoing values.

By way of example, 0.35 g Al(NO₃)₃·9H₂O can be dissolved in 25 mL of distilled water under continuous magnetic stirring for 10 min at 50° C. to provide a precursor solution in which the plurality of degraded lithium ion battery cathode particles are dispersed.

At step 106, following dispersion of the plurality of degraded lithium ion battery cathode particles in the precursor coating solution that includes the metal salt, a basic solution can be added to and mixed with the precursor coating solution at a concentration and temperature effective to act as a precipitant, and facilitate deposition of an ultrathin precursor coating layer that includes a metal of the dissolved metal salt on the dispersed the plurality of degraded lithium ion battery cathode particles.

In some embodiments, the basic solution can include an aqueous solution of at least one base selected from ammonium hydroxide (NH₄OH), sodium hydroxide (NaOH), potassium hydroxide (KOH), sodium carbonate (Na₂CO₃), sodium bicarbonate (NaHCO₃), lithium hydroxide (LiOH), or mixtures thereof. The basic solution can have a concentration of about 1M to about 10M, for example, about 2M to about 10M, about 3M to about 10M, about 4M to about 10M, about 5M to about 10M, about 5M to about 9M, or about 5M to about 8M, base, including ranges between any of the foregoing values, to provide a basic solution with a pH of at least about 9, at least about 10, at least about 11, at least about 12, at least about 13, or at least about 14.

In some embodiments, the temperature of the precursor solution can be raised prior to the addition of the basic solution to about 70° C. to about 90° C., for example, about 75° C. to about 90° C., about 80° C. to about 90° C., or about 85° C. to about 90° C., including ranges between any of the foregoing values, and maintained at this elevated temperature during mixing and deposition of the ultrathin precursor coating layer that includes a metal of the dissolved metal salt on the dispersed plurality of degraded lithium ion battery cathode particles.

The ultrathin precursor coating layer deposited on the plurality of degraded lithium ion battery cathode particles can include, for example, a metal coating, metal oxide coating, or metal hydroxide coating, that is based on the metal of the metal salt dissolved in the precursor solution, and advantageously can promote lithium migration to the plurality of degraded lithium ion battery cathode particles and be capable of reacting with a lithium ion source to form a lithium ion coating layer on the plurality of degraded lithium ion battery cathode particles. For example, the metal coating, metal oxide coating, or metal hydroxide coating can include at least one of Al(OH)₃, Al₂O₃, TiO₂, MgO, ZnO, Li₂SiO₃, Li₂TiO₃, LiZrO₃ or mixtures thereof.

By way of example, an aqueous precursor solution of dissolved aluminum nitrate (Al(NO₃)₃) metal salt and the dispersed the plurality of degraded lithium ion battery cathode particles can be heated to a temperature of about 90° C., and a 30 wt. % ammonium hydroxide solution can be gradually added to the precursor solution and stirred at a temperature of about 90° C. for about 1 hour. The aluminum nitrate serves as the metal source (i.e., aluminum source) for the coating, while the ammonia solution acts as the precipitant, facilitating the deposition of an ultrathin Al(OH)₃ layer on the surface of the degraded lithium ion battery cathode particles.

In some embodiments, the ultrathin precursor coating layer can have a thickness of about 5 nm to about 1 μm, about 5 nm to about 500 nm, about 5 nm to about 400 nm, about 5 nm to about 300 nm, about 5 nm to about 200 nm, about 5 nm to about 100 nm, about 5 nm to about 50 nm, or about 5 nm to about 20 nm, including ranges between any of the foregoing values.

The precursor layer coated plurality of degraded lithium ion battery cathode particles can be filtered from precursor solution, washed with, for example, distilled water, and dried.

At step 108, the precursor layer coated plurality of degraded lithium ion battery cathode particles can be sintered with a lithium ion source and directly regenerated such that the lithium component of the degraded lithium ion battery cathode particles is restored to the amount of lithium in the cathode particles of pristine commercially available lithium ion battery cathode materials and the precursor coating layer is converted to a metal oxide coating layer, such as a lithium oxide coating layer or lithium metal oxide coating layer, effective to enhance the electrochemical and/or thermal properties of the upcycled lithium ion battery cathode particles.

The precursor layer coated plurality of degraded lithium ion battery cathode particles can be sintered with a lithium ion source by mixing a particulate lithium ion source with the dried precursor layer coated plurality of degraded lithium ion battery cathode particles and sintering the mixture at a temperature and for a duration of time effective for lithium ions in the lithium ion source to migrate and reintegrate into the crystal lattice of the degraded lithium ion battery cathode particles, compensating for the lithium loss. Simultaneously, the structural degradations, including anti-site mixing and distorted spinel structure, are also repaired by the high calcination temperature of the sintering process. Additionally, during this sintering process, chemical reaction between the metal, metal oxide, or metal hydroxide of the precursor coating layer and the lithium ion source can occur, forming an ultrathin layer of lithium oxide or lithium metal oxide coating on the lithium ion battery cathode particle surface and providing regenerated or upcycled lithium ion battery cathode particles.

In some embodiments, the particulate lithium ion source can include an inorganic lithium salt, such as lithium hydroxide (LiOH), lithium carbonate (Li₂CO₃), lithium nitrate (LiNO₃), lithium sulfate (Li₂SO₄), lithium chloride (LiCl), lithium acetate (CH₃COOLi), lithium oxide (Li₂O), or mixtures thereof, as well as organic lithium compounds, such as lithium tert-butoxide (LiOC(CH₃)₃), lithium ethoxide (LiOC₂H₅), lithium stearate (Li(C₁₈H₃₅O₂), lithium acetate (CH₃COOLi), or mixtures thereof, alone or combination with the inorganic lithium salt. In one example, the lithium ion source is an excess of particulate LiOH, which is mixed with the precursor layer coated plurality of degraded lithium ion battery cathode particles and sintered.

In some embodiments, the precursor layer coated plurality of degraded lithium ion battery cathode particles and particulate lithium ion source can be sintered at a temperature of about 500° C. to about 700° C., for example, about 525° C. to about 675° C., about 550° C. to about 650° C., or about 575° C. to about 625° C., including ranges between any of the foregoing values, and maintained at this temperature for about 1 hour, 2 hours, 3 hours, 4 hours, or more to effect the formation of the lithium oxide or lithium metal oxide coating layer on the particles.

After sintering, the upcycled lithium ion battery cathode particles with the lithium oxide or lithium metal oxide coating on the lithium ion battery cathode particle surface can be washed with, for example, distilled water, dried by, for example, sublimation, in a vacuum oven, and then milled by, for example, ball milling to prevent agglomeration.

In some embodiments, the lithium oxide or lithium metal oxide coating layer can include about 1 wt. % to about 5 wt. % of the upcycled lithium ion battery cathode particles, for example, about 1 wt. % to about 4 wt. %, about 1 wt. % to about 3 wt. %, or about 1 wt. % to about 2 wt. % of the upcycled lithium ion battery cathode particles, including ranges between any of the foregoing values.

Optionally, during, before, or after the precursor coating layer formation step or the sintering step, the lithium ion battery cathode particles can be doped with at least one of Mg, Al, Ti, V, Zn, Nb, W, Ca, etc. using, for example, solid-state doping, wet-chemical doping, sol-gel doping, hydrothermal or ion-exchange doping, or atomic layer deposition, to further modify the electrochemical or thermal stability properties of the upcycled lithium ion battery cathode particles.

Advantageously, the upcycled lithium ion battery cathode materials showed substantial and unexpected improvements in electrochemical performance and thermal stability. In some embodiments, the upcycled lithium ion battery cathode material exhibits a higher discharge capacity and capacity retention compared to pristine lithium ion battery cathode material of the same or similar composition. In other embodiments, the upcycled lithium ion battery cathode material exhibits improved rate capability compared to pristine lithium ion battery cathode material of the same or similar composition. In still other embodiments, the upcycled lithium ion battery cathode material exhibits enhanced thermal stability, with, for example, less than 1% weight loss at temperatures up to 400° C., compared to a pristine lithium ion battery cathode material.

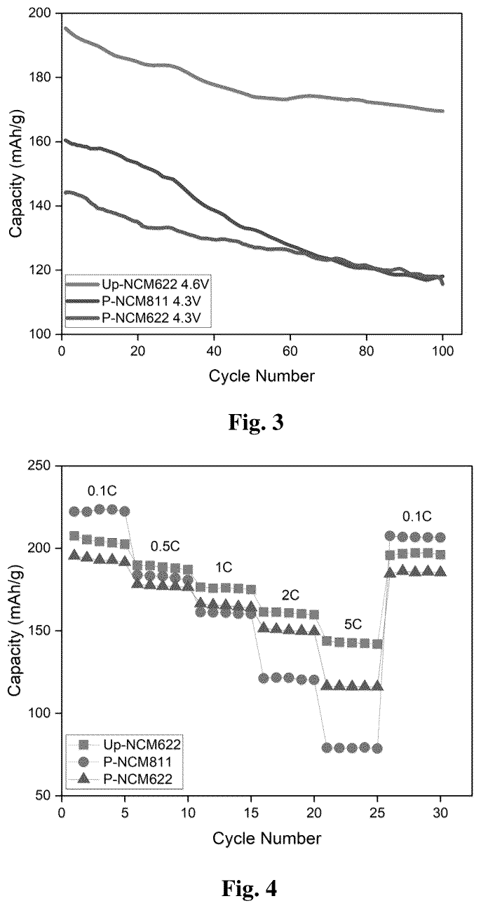

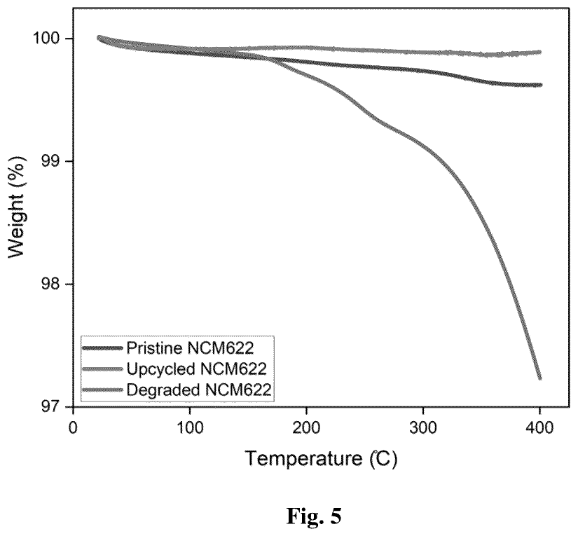

By way of example, degraded NCM622 with a 15% lithium loss was upcycled using the upcycling process described herein to provide upcycled NCM622 with a 2 wt. % LiAlO₂ coating. The electrochemical performance of the upcycled NCM622, evaluated using a Neware battery tester (Neware Ltd, China) with a cut-off voltage of 4.6V, shows remarkable improvements. Specific capacity and cycling performance are shown in FIG. 3, and rate capability results are shown in FIG. 4. The upcycled NCM622 exhibits superior cycling stability at 4.6V, maintaining 87% capacity retention over 100 cycles, which is higher than that of pristine NCM622 and NCM811 at 4.3V. The specific capacity of the upcycled NCM622 reaches 195.3 mAh/g at a 1 C rate, surpassing those of pristine NCM622 and NCM811. Additionally, the upcycled NCM622 demonstrates an exceptional rate capability, attributed to the LiAlO₂ coating layer, achieving 143.3 mAh/g at a 5 C rate. The thermal stability is also enhanced, with only a 1% weight loss observed at 400° C., as illustrated in FIG. 5. Therefore, the upcycled NCM622 shows a higher energy density, power performance, and safety than pristine NCM622 and NCM811. Consequently, the upcycling method described herein successfully restores the crystal structure of degraded cathode materials, significantly boosts their electrochemical performance, and ensures they meet the stringent performance and safety standards required for lithium-ion batteries in electric vehicles. This low-cost method significantly advances the performance and safety of lithium-ion batteries, offering promising implications for future battery recycling technology.

The following example is included to demonstrate preferred embodiments of the invention. It should be appreciated by those of skill in the art that the techniques disclosed in the example, which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE

This example describes an upcycling method to enhance the electrochemical performance of degraded NCM622 cathode materials. The upcycling process simultaneously accomplishes two key objectives: fully recovering both lithium loss and structural degradation while converting the coating precursor to a LiAlO₂ layer. By addressing these aspects, this dual-function approach operates at a low temperature with a short sintering time, significantly enhancing the electrochemical performance of the degraded NCM622 while minimizing energy consumption and cost. Through the efficient integration of processes, the proposed upcycling method represents a novel approach to revitalizing the degraded cathode active materials, effectively addressing the growing demand for high-performance battery components while advancing the sustainable development goals of the lithium-ion battery industry.

### Material Preparation

Pristine NCM (P-NCM) was purchased from MTI. To prepare the degraded NCM (D-NCM), as-received P-NCM was immersed in a redox solution under continuous stirring to achieve the delithiation process. The solution was made by dissolving 3.5 g potassium persulfate (K2S2O8, Sigma Aldrich) in 400 ml distilled water, with continuous stirring at 50° C. until complete dissolution. 10 g pristine NCM622 was then dispersed into the solution and subjected to magnetic stirring at 60° C. for 12 hours. Then, the solution was filtered, and the obtained black powder was washed 3 times with distilled water. The D-NCM was subsequently dried in a vacuum oven at 120° C. for 2 hours. The final lithium leaching rate of the D-NCM was approximately 15%.

### Direct Upcycling of Cathode Materials

Referring to FIG. 2, to prepare the coating solution, 0.35 g Al(NO₃)₃ was added and stirred in the 25 mL distilled water until fully dissolved. Subsequently, 3 g D-NCM was dispersed into the solution and the solution was magnetically stirred at 50° C. for 10 min. The temperature of the solution was then increased to 90° C., and 15 mL (30 wt %) ammonium hydroxide was gradually added to the solution. The solution was continuously stirred magnetically for 1 h. Then, the solution was filtered, and the black powder was washed 3 times with distilled water. An excess of 5% LiOH (0.15 g) was added to the dried powder, and the mixture was then sintered in a furnace at 600° C. for 4 h. The upcycled NCM622 (Up-NCM-2) with 2 wt. % LiAlO₂ coating layer was finally obtained by grinding the sintered powder using a mortar and pestle. The prepared cathode materials are labeled Up-NCM-1 (1 wt. % LiAlO₂), Up-NCM-2 (2 wt. % LiAlO₂), and Up-NCM-3 (3 wt. % LiAlO₂).

TABLE

| Sample | Composition |
|---|---|
| RLA2-NCM | Li_{1.156}Ni_{0.641}Co_{0.211}Mn_{0.189}O₂— (LiAlO₂)_{0.03} |
| P-NCM | Li_{1.146}Ni_{0.644}Co_{0.216}Mn_{0.189}O₂ |
| D-NCM | Li_{0.986}Ni_{0.643}Co_{0.217}Mn_{0.182}O₂ |

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, we claim:

1. A method for upcycling degraded cathode materials for lithium-ion batteries, comprising:
applying by wet chemical methods a precursor coating layer to degraded lithium ion cathode material particles with lithium loss; and
sintering the precursor layer coated lithium cathode material particles with a lithium ion source at a temperature and for a duration of time effective to restore the lithium component of the lithium ion cathode material particles and convert the precursor coating layer to a lithium oxide or lithium metal oxide coating layer effective to enhance the electrochemical and/or thermal properties of the lithium ion battery cathode material particles.

2. The method of claim 1, wherein the precursor coating layer is applied to the degraded lithium ion cathode material particles with lithium loss by dispersing the degraded lithium ion cathode material particles in a precursor coating solution containing a metal salt; and
adding a basic solution to the dispersion to facilitate deposition of the precursor coating layer that includes a metal of the metal salt on the dispersed degraded lithium ion cathode material particles.

3. The method of claim 1, wherein the degraded cathode material is selected from LiNiCoMnO₂ (NCM) LiCoO₂ (LCO), LiMn₂O₄ (LMO), LiFePO₄ (LFP), LiNiMnCoO₂ (NMC), LiNiCoAlO₂ (NCA), LiNiO₂, LiCrO₂, LiV₂O₅, LiTiS₂, LiMOS₂, LiMnO₂, lithium nickel oxides, lithium nickel manganese oxides, lithium nickel manganese cobalt oxides, LiNi_{0.333}Co_{0.333}Mn_{0.333}O₂ (NCM111), LiNi_{0.5}Co_{0.2}Mn_{0.3}O₂ (NCM523), LiNi_{0.6}Co_{0.2}Mn_{0.2}O₂ (NCM622), LiNi_{0.7}Co_{0.1}Mn_{0.2}O₂, or LiNi_{0.8}Co_{0.1}Mn_{0.1}O₂ (NCM811), each with at least about 10% or more Li loss.

4. The method of claim 2, wherein the metal salt in the precursor coating solution is selected from aluminum nitrate, titanium chloride, magnesium nitrate, zinc nitrate, lithium silicate, lithium titanate, lithium zirconate, or mixtures thereof.

5. The method of claim 2, wherein the basic solution is selected from ammonium hydroxide (NH₄OH), sodium hydroxide (NaOH), potassium hydroxide (KOH), sodium carbonate (Na₂CO₃), sodium bicarbonate (NaHCO₃), lithium hydroxide (LiOH), or mixtures thereof.

6. The method of claim 1, wherein the lithium oxide or lithium metal oxide coating layer comprises about 1 wt. % to about 5 wt. % of the upcycled lithium ion cathode material.

7. The method of claim 1, wherein the precursor layer coated lithium cathode material particles and lithium ion source are sintered at a temperature of about 500° C. to about 700° C.

8. The method of claim 1, wherein the degraded lithium ion cathode material particles or upcycled lithium ion cathode material particles are doped with at least one of Mg, Al, Ti, V, Zn, Nb, W, Ca, etc.

9. The method of claim 1, wherein the lithium source includes particulate lithium hydroxide.

10. The method of claim 1, wherein the precursor coating layer of the precursor layer coated lithium ion cathode material particles prior to sintering includes a metal, metal oxide, or metal hydroxide coating.

11. The method of claim 10, wherein the metal oxide or metal hydroxide coating comprises at least one of Al(OH)₃, Al₂O₃, TiO₂, MgO, ZnO, Li₂SiO₃, Li₂TiO₃, LiZrO₃ or mixtures thereof.

12. The method of claim 11, the metal hydroxide coating comprises an Al(OH)₃ coating.

13. The method of claim 12, wherein the Al(OH)₃ coating is formed on particles of degraded lithium ion cathode material particles by mixing the particles with an aqueous solution of Al(NO₃)₃ and adding a NH₃·H₂O water solution to the mixture at an amount effective to form degraded lithium ion cathode material particles coated with Al(OH)₃.

14. The method of claim 1, wherein the lithium oxide or lithium metal oxide coating comprises a LiAlO₂ coating.

15. The method of claim 1, wherein the upcycled lithium ion cathode material exhibits a higher discharge capacity and capacity retention compared to pristine cathode material of the same composition.

16. The method claim 1, wherein the upcycled lithium ion cathode material exhibits improved rate capability compared to pristine cathode material of the same composition.

17. The method of claim 1, wherein the upcycled lithium ion cathode material exhibits enhanced thermal stability, with less than 1% weight loss at temperatures up to 400° C., compared to a pristine cathode material.

18. An upcycled cathode material for lithium-ion batteries produced by the method of claim 1.

19. A lithium-ion battery comprising the upcycled cathode material of claim 18.

20. The lithium-ion battery of claim 19, wherein the battery exhibits improved electrochemical performance and thermal stability compared to a battery using pristine cathode material of the same composition.
